(19) United States
(12) Patent Application Publication
(10) Pub. No.: US 2006/0077667 A1
(43) Pub. Date: Apr. 13, 2006

(54) Lighting device

(75) Inventors: Tat Nin Lui, Hong Kong (HK); Scott Sze Kok Fong, Aberdeen (HK); Chao Hua Jian, Shenzhen (CN)

Correspondence Address: LEYDIG VOIT & MAYER, LTD, 700 THIRTEENTH ST. NW, SUITE 300, WASHINGTON, DC, 20005-3960, US

(73) Assignee: Choon Nang Electrical Appliance Mfy., Ltd., Aberdeen (HK)

(21) Appl. No.: 10/959,179

(22) Filed: Oct. 7, 2004

(51) Int. Cl. F21V 7/00

(52) U.S. Cl. 362/300

(57) ABSTRACT

A lighting device (50) comprises a light source (40) e.g. LED, a convex reflector (43) for receiving light from the LED (40), and a concave reflector (41) for receiving light from the convex reflector (43). A relatively narrow angled light beam from the LED (40) is diverged by the convex reflector (43) and then converged by the concave reflector (41) into a relatively broader parallel light beam. The two reflectors (43 & 41) may be replaced by plano-concave and convex lens (143 & 141) respectively.

The subject invention relates to a lighting device that may be, for example, a flashlight or torch or only a part of lighting apparatus.

### BACKGROUND OF THE INVENTION

Lighting devices and especially flashlights are used to meet various household, workplace and recreational needs. Conventional flashlights typically incorporate tungsten light bulbs, and lately quartz light bulbs, as the light source, but they are power consuming. High-power or super-bright light emitting diodes (LED) are becoming increasingly popular as, while they can output comparable light, they consume a great deal less power and generate much less heat, and they have a very long service life. However, the light emitted by such LEDs has a relatively narrow angle of illumination compared with the conventional light bulbs. This makes traditional beaming systems unsuitable, especially for creating a relatively broader parallel light beam.

The invention seeks to obviate or at least alleviate such shortcoming by providing an improved or new lighting device.

### SUMMARY OF THE INVENTION

According to the invention, there is provided a lighting device comprising:
a light source for emitting a relatively narrow angled light beam about a central axis;
a divergent optical element located forward of the light source for receiving light therefrom, the divergent optical element having a central axis aligned with that of the light source; and
a convergent optical element located forward of the light source for receiving light from the divergent optical element, the convergent optical element having a central axis aligned with that of the divergent optical element;
whereby a relatively narrow angled light beam from the light source is diverged by the divergent optical element and then converged by the convergent optical element into a relatively broader substantially parallel light beam.

Preferably, the light source comprises a light emitting diode.

In a first preferred embodiment, the divergent optical element comprises a convex reflector for reflecting light from the light source, and the convergent optical element comprises a concave reflector for reflecting light from the convex reflector.

More preferably, the convex reflector is located forward of and facing the concave reflector, and has an aperture for light from the light source to pass through to reach the convex reflector.

Further more preferably, the lighting device includes a holder holding the light source completely behind a reflecting surface of the concave reflector.

Yet further more preferably, the holder is fixed on the back of the concave reflector.

Still yet further more preferably, the holder has a tunnel which leads to the reflecting surface of the concave reflector and in which the light source is located.

It is preferred that the lighting device includes a light transmissive cover located forward of the concave reflector, on which the convex reflector is located.

It is further preferred that the concave reflector has a periphery, across which the cover is located.

Preferably, the lighting device includes a convergent lens located between the light source and the convex reflector for converging light from the light source into a substantially parallel light beam before reaching the convex reflector.

More preferably, the convergent lens is located completely behind a or the reflecting surface of the concave reflector.

It is preferred that the convex and concave reflectors comprise respective substantially parabolic reflectors.

It is further preferred that the convex and concave reflectors are located such that their focal points coincide.

In a second preferred embodiment, the divergent optical element comprises a divergent lens for diverging light from the light source, and the convergent optical element comprises a convergent lens for converging light from the divergent lens.

More preferably, the convergent lens is located forward of the divergent lens.

It is preferred that the lighting device includes a holder holding the light source and the divergent lens.

It is further preferred that the holder comprises a cylinder having opposite first and second ends holding the light source and the divergent lens respectively, the second end comprising an end wall that provides the divergent lens.

Preferably, the lighting device includes a reflector cup located co-axially about the central axis and behind the convergent lens.

More preferably, the light source is located completely behind the reflector cup and the divergent lens is located inside the reflector cup.

It is preferred that the divergent lens is arranged to diverge a relatively narrow angled light beam from the light source into a relatively wider angled light beam having a vertex that falls inside the reflector cup.

It is preferred that the divergent lens is arranged to diverge a relatively narrow angled light beam from the light source into a relatively wider angled light beam having a vertex that falls forward of and outside the light source.

### BRIEF DESCRIPTION OF DRAWINGS

The invention will now be more particularly described, by way of example only, with reference to the accompanying drawings, in which:

FIG. 1 is a cross-sectional side view of a first embodiment of a lighting device in accordance with the invention;

FIG. 2 is a cross-sectional side view of a flashlight incorporating the lighting device of FIG. 1;

FIG. 3 is a cross-sectional side view of the lighting device of FIG. 1, which has been modified;

FIG. 4 is a cross-sectional side view of a flashlight incorporating the lighting device of FIG. 3;

FIG. 5 is a cross-sectional side view of a second embodiment of a lighting device in accordance with the invention; and

FIG. 6 is a cross-sectional side view of a flashlight incorporating the lighting device of FIG. 5.

### DETAILED DESCRIPTION OF PREFERRED EMBODIMENTS

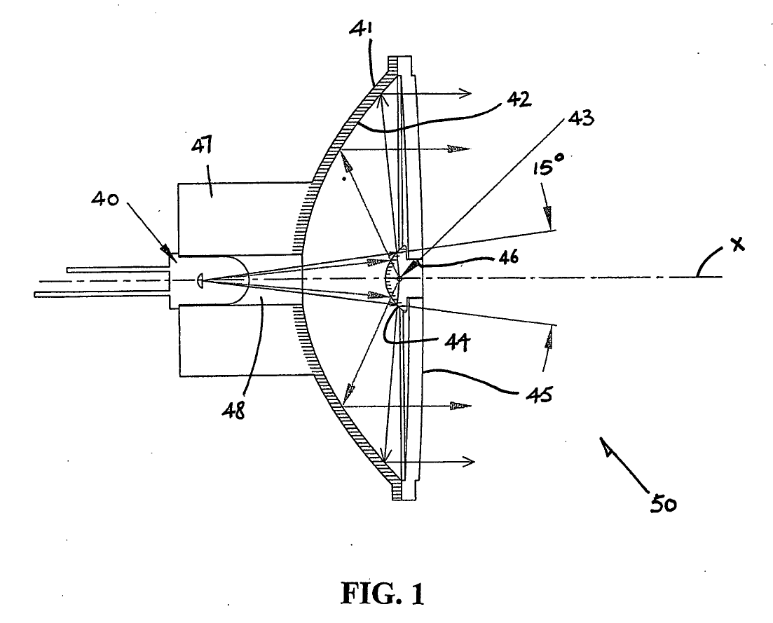

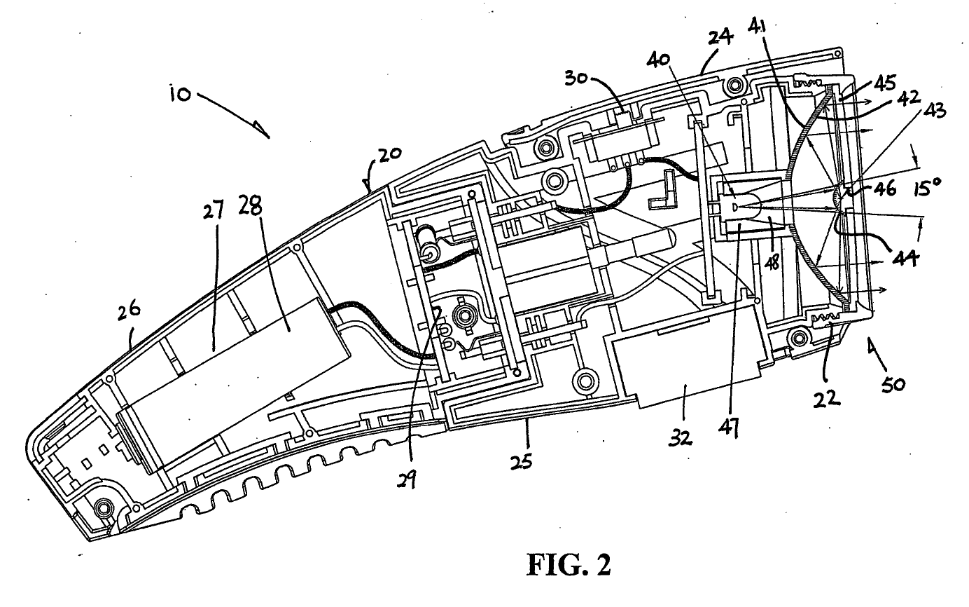

Referring initially to FIGS. 1 and 2 of the drawings, there is shown a flashlight 10 incorporating a first lighting device 50 embodying the invention, that being a lighting head 50 for the flashlight 10. The flashlight 10 includes an oblong casing 20 having an open front end 24, a middle portion 25 and a closed rear end 26, an on/off switch 30 on one casing side and a magnetic catch 32 on the opposite casing side.

The rear casing end 26 defines an internal compartment 27 for holding a battery cell 28. An electronic circuit 29 in the middle casing portion 25 controls the operation of the lighting head 50 energized by the battery cell 28. The switch 30 is connected in series with the battery cell 28, etc. for switching the lighting head 50 on and off.

The lighting head 50, which is housed almost fully within the front casing end 24, comprises a super-bright LED 40, a circular concave light reflector 41, a circular convex light reflector 43 and a transparent (or translucent) disc-like cover 45. The LED 40 in use emits a relatively narrow angled light beam (of over 90% of its total light output) about a central axis X, typically at a conical angle in the range of 10° to 20° for example 15°.

The concave reflector 41 is positioned forward of and centrally aligned with the LED 40 about the axis X, having a parabolic concave reflecting surface 42. The back of the concave reflector 41 is integrally expanded to form a tubular holder 47 holding the LED 40 completely behind the reflecting surface 42. The holder 47 has a central tunnel 48 which leads to and forms a central aperture at the reflecting surface 42 at a front end, whose rear end receives and locates the LED 40 about the axis X.

The concave reflector 41 has a circular rim across which the cover 45 is located by a screw-on collar 22 as part of the casing front end 24. The cover 45 has a central hole 46 that holds the convex reflector 43 by an axial stem thereof, on an inner surface of the cover 45. The convex reflector 43 has a slightly hyperbolic (near-parabolic) convex reflecting surface 44 whose central axis coincides with that of the LED 40 and the concave reflector 41.

The two reflectors 41 and 42 are co-axially aligned and are located relative to each other such that their focal points coincide. The arrangement is such that a relatively narrow parallel light beam incident centrally upon the convex reflector 43 will be reflected by this reflector 43 and then the other, concave reflector 41 into a considerably broader parallel light beam.

The operation of the lighting head 50 is now described. A relatively narrow angled light beam emitted by the LED 40 passes through the tunnel 48 and the concave reflector 41 and then impinges upon the convex reflector 43, which is next reflected by the convex reflector 43 to shine upon the concave reflector 41 and is finally reflected by the concave reflector 41 to form a relatively broad parallel light beam projecting forwardly through the cover 45 for illumination.

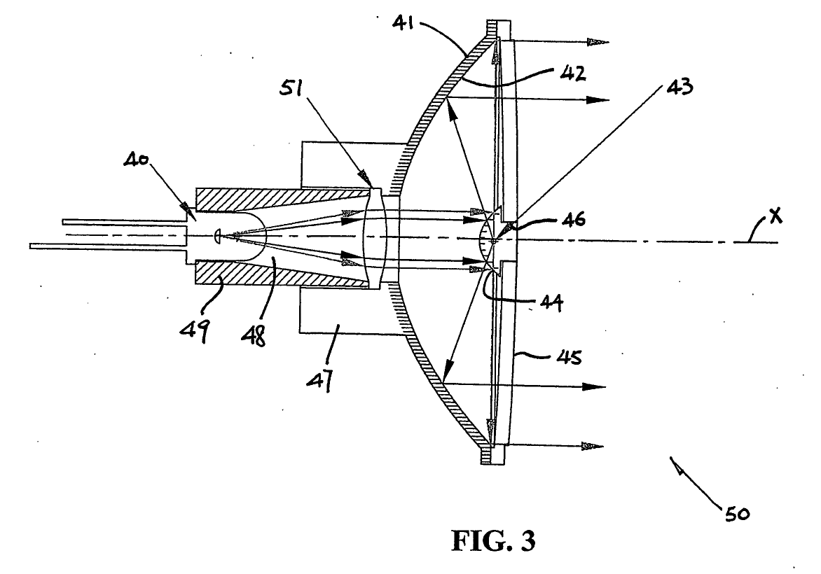

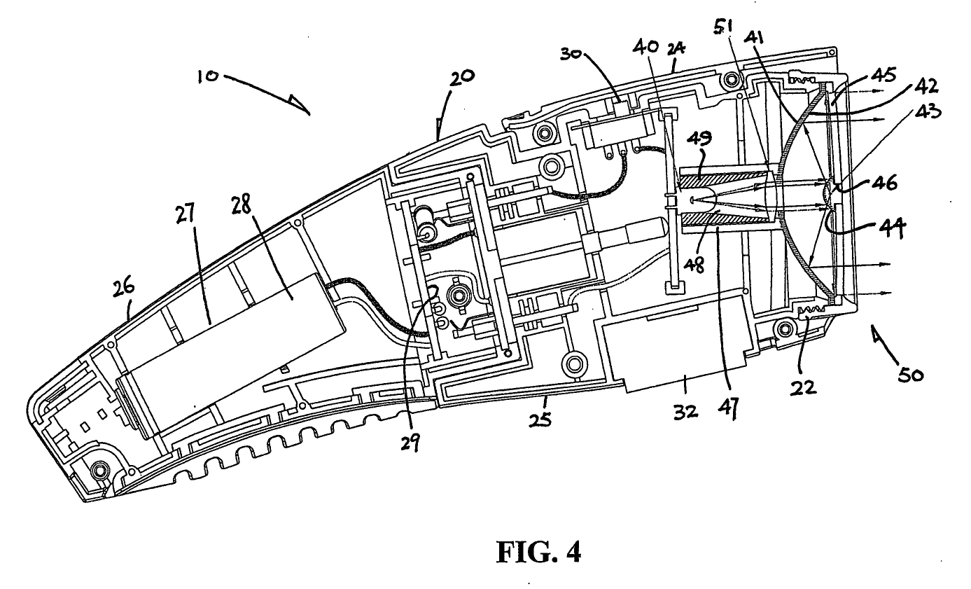

The lighting head 50 may be modified to the design as shown in FIGS. 3 and 4, in which a double-convex convergent lens 51 is added, that being the major difference. The lens 51 is located between the LED 40 and the convex reflector 43, at a position completely behind the reflecting surface 42 of the concave reflector 41. The holder 47 has a separate cylindrical core 49 defining the tunnel 48, which is inserted into the holder 47 after the lens 51 to fix the lens 51 against a slightly restricted end of the holder cavity locating the core 49.

The lens 51 serves to converge the angled light beam from the LED 40 into a parallel light beam before the beam impinges upon the convex reflector 43. With the lens 51 correcting the LED light beam to become parallel, a truly parabolic convex reflector 43 can be used instead of a near-parabolic one that being non-standard and relatively harder and more costly to manufacture.

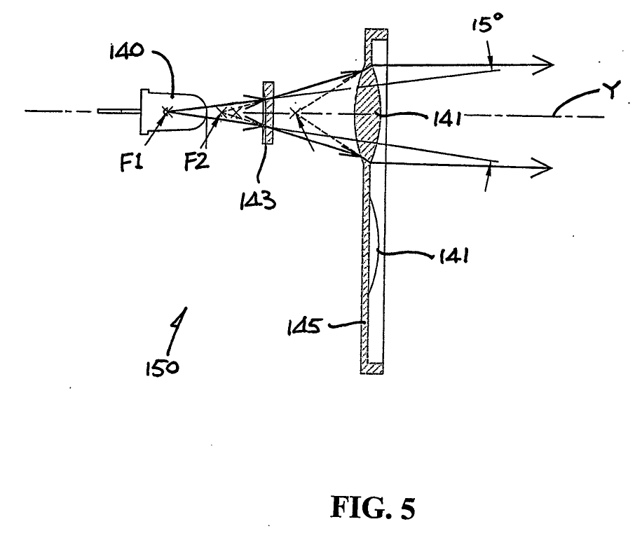

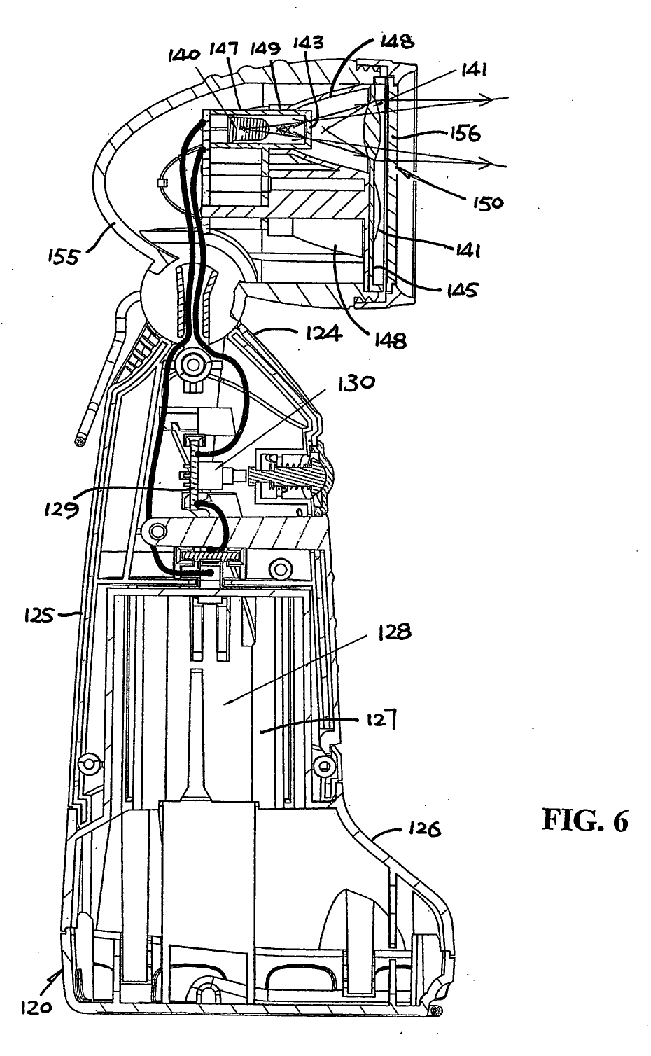

Reference is now made to FIGS. 5 and 6, which show a different typed of flashlight 110 incorporating a second lighting device 150 embodying the invention, likewise acting as a lighting head 150 therefor. An upright casing 120 of the flashlight 110 has an upper end 124 to which the lighting head 150 is connected, a middle portion 125 and a base 126. The base 126 defines an internal compartment 127 holding a rechargeable battery pack 128 for energizing the lighting head 150.

The flashlight 110 includes an electronic circuit 129 in the middle casing portion 125 for controlling the operation of the lighting head 150, to which the battery pack 128 is connected in series via an on/off switch 130. The switch 130 is operable on the front side of the casing 120 for switching the lighting head 150 on and off.

The lighting head 150 has a triangular array of three identical lighting 153 for broader illumination, each comprising a super-bright LED 140, a convex convergent lens 141, a plano-concave divergent lens 143 and a parabolic reflector cup 148, all of which are co-axially aligned about a common central axis Y. The lighting units 153 are together fully encased in an oval shell 155 which is hinged to the casing 120 for pivoting up and down to illuminate at an adjustable angle. The shell 155 has an open front closed by a transparent (or translucent) disc-like cover 156.

Each LED 140 in use emits, from an internal filament F1 thereof, a relatively narrow angled light beam (of over 90% of its total light output) about the axis Y, typically at a conical angle in the range of 10° to 20° for example 15°.

The construction of the lighting units 153 is now described in further detail. Each LED 140 is co-axially held in a cylinder 147 at a rear end thereof, whose front end has a transparent wall providing the divergent lens 143. The convergent lens 141 is located forward of the divergent lens 143, and behind the convergent lens 141 the reflector cup 148 is positioned facing forwards. The reflector cup 148 has a tubular rear end 149 which is disposed about the front end of the LED holder 147 such that the divergent lens 143 is held inside the reflector cup 148 and the LED 140 is placed completely behind the reflector cup 148. Overall, the three convergent lenses 141 are integrally formed on a single plastics disc mounted right behind the cover 156.

The operation of the lighting units 153 is now described. A relatively narrow angled light beam emitted by the LED 140 passes through the divergent lens 143 and is thereby diverged into a relatively wider angled light beam. This widened light beam has a vertex F2 and, upon subsequently passing through the convergent lens 141, is converged into a relatively broad parallel light beam that projects forwardly through the cover 156 for illumination.

As the angled light beam is widened, its vertex F2 is moved forwards from the LED filament F1 and falls outside the body of the LED 140. In addition, the vertex F2 falls inside the reflector cup 148 and preferably coincides with its focus such that the remainder light rays (less than 10%) radiating at greater angles outside the main beam are collected and reflected to project straight ahead with the aforesaid parallel light beam.

It is understood that all the reflectors and lenses herein described, including the reflectors 41 and 43 and lenses 141 and 143 in particular, are fundamentally optical elements as they treat or process light rays and are herein collectively referred to as such.

The invention has been given by way of example only, and various modifications of and/or alterations to the described embodiments may be made by persons skilled in the art without departing from the scope of the invention as specified in the appended claims.

1. A lighting device comprising:
a light source for emitting a relatively narrow angled light beam about a central axis;
a divergent optical element located forward of the light source for receiving light therefrom, the divergent optical element having a central axis aligned with that of the light source; and
a convergent optical element located forward of the light source for receiving light from the divergent optical element, the convergent optical element having a central axis aligned with that of the divergent optical element;
whereby a relatively narrow angled light beam from the light source is diverged by the divergent optical element and then converged by the convergent optical element into a relatively broader substantially parallel light beam.

2. The lighting device as claimed in claim 1, wherein the light source comprises a light emitting diode.

3. The lighting device as claimed in claim 1, wherein the divergent optical element comprises a convex reflector for reflecting light from the light source, and the convergent optical element comprises a concave reflector for reflecting light from the convex reflector.

4. The lighting device as claimed in claim 3, wherein the convex reflector is located forward of and facing the concave reflector, and has an aperture for light from the light source to pass through to reach the convex reflector.

5. The lighting device as claimed in claim 4, including a holder holding the light source completely behind a reflecting surface of the concave reflector.

6. The lighting device as claimed in claim 5, wherein the holder is fixed on the back of the concave reflector.

7. The lighting device as claimed in claim 6, wherein the holder has a tunnel which leads to the reflecting surface of the concave reflector and in which the light source is located.

8. The lighting device as claimed in claim 3, including a light transmissive cover located forward of the concave reflector, on which the convex reflector is located.

9. The lighting device as claimed in claim 8, wherein the concave reflector has a periphery, across which the cover is located.

10. The lighting device as claimed in claim 3, including a convergent lens located between the light source and the convex reflector for converging light from the light source into a substantially parallel light beam before reaching the convex reflector.

11. The lighting device as claimed in claim 10, wherein the convergent lens is located completely behind a or the reflecting surface of the concave reflector.

12. The lighting device as claimed in claim 3, wherein the convex and concave reflectors comprise respective substantially parabolic reflectors.

13. The lighting device as claimed in claim 12, wherein the convex and concave reflectors are located such that their focal points coincide.

14. The lighting device as claimed in claim 1, wherein the divergent optical element comprises a divergent lens for diverging light from the light source, and the convergent optical element comprises a convergent lens for converging light from the divergent lens.

15. The lighting device as claimed in claim 14, wherein the convergent lens is located forward of the divergent lens.

16. The lighting device as claimed in claim 14, including a holder holding the light source and the divergent lens.

17. The lighting device as claimed in claim 16, wherein the holder comprises a cylinder having opposite first and second ends holding the light source and the divergent lens respectively, the second end comprising an end wall that provides the divergent lens.

18. The lighting device as claimed in claim 14, including a reflector cup located co-axially about the central axis and behind the convergent lens.

19. The lighting device as claimed in claim 18, wherein the light source is located completely behind the reflector cup and the divergent lens is located inside the reflector cup.

20. The lighting device as claimed in claim 18, wherein the divergent lens is arranged to diverge a relatively narrow angled light beam from the light source into a relatively wider angled light beam having a vertex that falls inside the reflector cup.

21. The lighting device as claimed in claim 14, wherein the divergent lens is arranged to diverge a relatively narrow angled light beam from the light source into a relatively wider angled light beam having a vertex that falls forward of and outside the light source.
